(19) United States
(12) Patent Application Publication
(10) Pub. No.: US 2011/0187891 A1
(43) Pub. Date: Aug. 4, 2011

(54) Methods and Systems for Automatic White Balance

(76) Inventor: Buyue Zhang, Plano, TX (US)

(21) Appl. No.: 13/011,653

(22) Filed: Jan. 21, 2011

Related U.S. Application Data
(60) Provisional application No. 61/301,326, filed on Feb. 4, 2010.

(51) Int. Cl. H04N 9/73

(52) U.S. Cl. 348/223.1; 348/E09.051

(57) ABSTRACT

A method for automatic white balance (AWB) in a digital system is provided that includes applying predetermined flash red, blue, and green gain values stored in the digital system to white balance a digital image when a flash is used to capture the digital image, and applying computed red, blue, and green gain values to white balance a digital image when the flash is not used to capture the digital image. Another method for AWB is provided that includes computing red, blue, and green gain values for white balancing a digital image, adjusting the computed red, blue, and green gain values with respective predetermined flash red, blue, and green gain adjustment values when the flash is used to capture the digital image, and applying the adjusted red, blue, and green gain values to white balance the digital image.

### CROSS-REFERENCE TO RELATED APPLICATIONS

This application claims benefit of U.S. Provisional Patent Application Ser. No. 61/301,326, filed Feb. 4, 2010, which is incorporated by reference herein in its entirety. This application is related to U.S. patent application Ser. No. 12/510,853, filed Jul. 28, 2009, which is incorporated by reference herein in its entirety. This application is also related to U.S. patent application Ser. No. 12/700,671, filed Feb. 4, 2010, U.S. patent application Ser. No. 12/710,344, filed Feb. 22, 2010, and U.S. patent application Ser. No. ______ (TI-69005), filed Jan. ______, 2011, which are incorporated by reference herein in their entirety.

### BACKGROUND OF THE INVENTION

White balance is the process of removing unrealistic color cast from a digital image caused by the color of the illumination. Human eyes automatically adapt to the color of the illumination, such that white will always appear white. Unfortunately, image capture devices (e.g., camera sensors) cannot adapt automatically. Therefore, white balance techniques are needed for image sensors in image capture systems (e.g., a digital camera) to compensate for the effect of illumination.

Automatic white balance (AWB) is an essential part of the imaging system pipeline in image capture systems. Digital still cameras and camera phones, for example, apply AWB techniques to correctly display the color of digital images. The quality of AWB has been a differentiating factor for different camera brands. Commonly used AWB techniques may not work very well on digital images captured using a flash. For example, a greenish cast may remain in such a digital image after the application of AWB. Accordingly, improvements in automatic white balance in order to improve the quality of digital images captured by image capture systems are desirable.

### BRIEF DESCRIPTION OF THE DRAWINGS

Particular embodiments in accordance with the invention will now be described, by way of example only, and with reference to the accompanying drawings:

FIG. 1 shows a block diagram of a digital system in accordance with one or more embodiments of the invention;

FIG. 2 shows a block diagram of an image processing pipeline in accordance with one or more embodiments of the invention;

FIGS. 3A and 3B show block diagrams of automatic white balance flow in accordance with one or more embodiments of the invention;

FIGS. 4A and 4B show block diagrams of a simulation system in accordance with one or more embodiments of the invention;

FIG. 4C shows a block diagram of an automatic white balance calibration system in accordance with one or more embodiments of the invention;

FIGS. 5A, 5B, and 7-9 show flow graphs of methods in accordance with one or more embodiments of the invention;

FIG. 6 shows an example of flash and non-flash references in accordance with one or more embodiments of the invention; and

FIG. 10 shows a block diagram of a digital system in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” and derivatives thereof are intended to mean an indirect, direct, optical, and/or wireless connection. Thus, if a first device or component couples to a second device or component, that connection may be through a direct connection, through an indirect connection via other devices and connections, through an optical connection, and/or through a wireless connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, combined, and/or performed in a different order than the order shown in the figures and/or described herein. Accordingly, embodiments of the invention should not be considered limited to the specific ordering of steps shown in the figures and/or described herein.

In general, embodiments of the invention provide methods and systems for automatic white balance in digital systems that capture digital images. In general, these methods recognize that the light from a flash used in capturing digital images is an important light source that directly affects the color appearance the digital images. In one or more embodiments of the invention, a digital image is a block of pixels such as single photograph, a subset of a photograph, a frame (or other subset) of a digital video sequence, etc. In one or more embodiments of the invention, a digital system that is configured to capture digital images implements an automatic white balance (AWB) method. In some embodiments of the invention, the AWB method is reference-based, i.e., is calibrated with references generated using an AWB calibration system. The references may include any combination of references such as color temperature references, scene prototype references, and the like. In some embodiments of the invention, the references include flash references for use in white balancing digital images captured using a flash. In some such embodiments, the reference-based AWB uses the flash references for white balancing digital images captured using the flash and uses other references, i.e., non-flash references, for white balancing digital images captured without using a flash.

In some embodiments of the invention, digital images captured using a flash are automatically white balanced using predetermined white balance gains for red, green, and blue and digital images captured without using a flash are automatically white balanced using white balance gains for red, green, and blue determined using references. In some embodiments of the invention, white balance gains for red, green, and blue are automatically determined for a digital image using references. Once these white balance gains are determined, they are used to white balance the digital image unless the digital image was captured using a flash. In this latter case, the white balance gains are adjusted by predetermined flash gain adjustment values before being used to white balance the digital image.

A reference used in the reference-based AWB may include statistics (e.g., a histogram) of an image used to generate the reference and/or one or more gray values (e.g., R, G, B, Cb, Cr values extracted from gray areas in an image). In general, reference-based AWB techniques compare statistics extracted from an image (e.g., the current video frame) to statistics extracted from a set of references to determine which reference best matches the image and then perform white balance correction on the image based on the estimated scene illumination. U.S. patent application Ser. No. 12/510,853, U.S. patent application Ser. No. 12/700,671, U.S. patent application Ser. No. 12/710,344, and U.S. patent application Ser. No. ______ (TI-69005) provide more detailed descriptions of example AWB techniques and AWB reference generation techniques that may be used in embodiments of the invention.

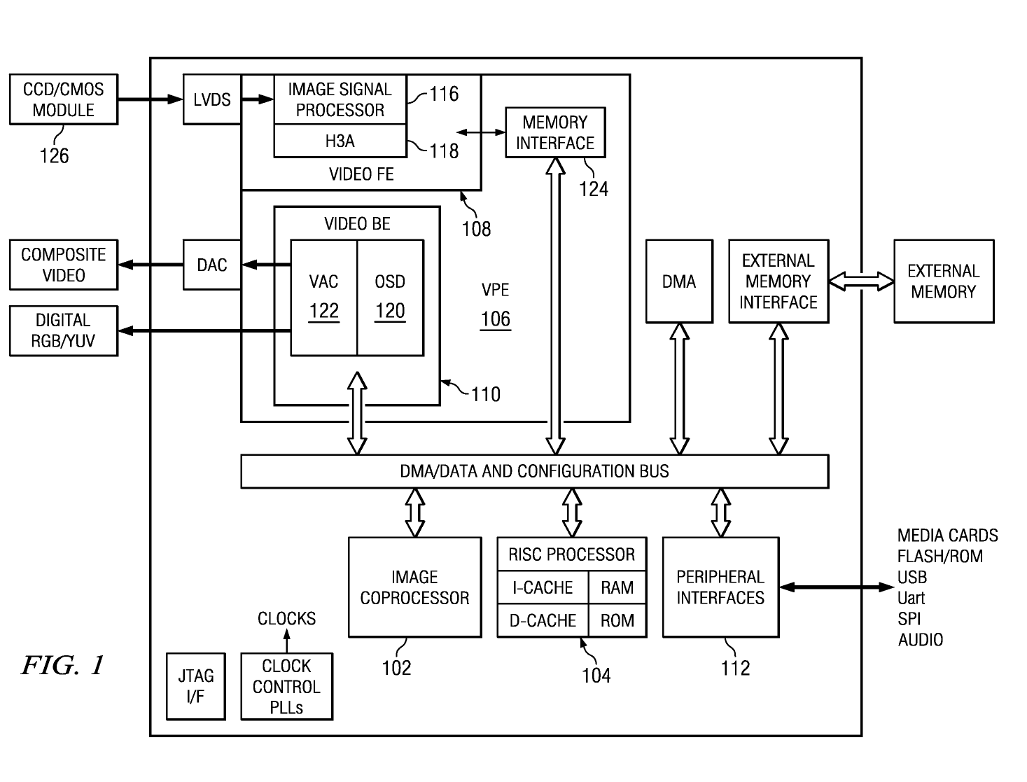

FIG. 1 shows a digital system suitable for an embedded system (e.g., a digital camera) in accordance with one or more embodiments of the invention that includes, among other components, a DSP-based image coprocessor (ICP) (102), a RISC processor (104), and a video processing engine (VPE) (106) that may be configured to perform an AWB method as described herein. The RISC processor (104) may be any suitably configured RISC processor. The VPE (106) includes a configurable video processing front-end (Video FE) (108) input interface used for video capture from imaging peripherals such as image sensors, video decoders, etc., a configurable video processing back-end (Video BE) (110) output interface used for display devices such as SDTV displays, digital LCD panels, HDTV video encoders, etc, and memory interface (124) shared by the Video FE (108) and the Video BE (110). The digital system also includes peripheral interfaces (112) for various peripherals that may include a multi-media card, an audio serial port, a Universal Serial Bus (USB) controller, a serial port interface, etc.

The Video FE (108) includes an image signal processor (ISP) (116), and an H3A statistic generator (H3A) (118). The ISP (116) provides an interface to image sensors and digital video sources. More specifically, the ISP (116) may accept raw image/video data from a sensor module (126) (e.g., CMOS or CCD) and can accept YUV video data in numerous formats. The ISP (116) may also receive a flash usage indicator from a flash unit, i.e., strobe unit, (not shown) when a flash is used to add additional light to the scene as the sensor module (129) is capturing the raw image/video data. The ISP (116) also includes a parameterized image processing module with functionality to generate image data in a color format (e.g., RGB) from raw CCD/CMOS data. The ISP (116) is customizable for each sensor type and supports video frame rates for preview displays of captured digital images and for video recording modes. The ISP (116) also includes, among other functionality, an image resizer, statistics collection functionality, and a boundary signal calculator. The H3A module (118) includes functionality to support control loops for auto focus, auto white balance, and auto exposure by collecting metrics on the raw image data from the ISP (116) or external memory. In one or more embodiments of the invention, the Video FE (108) is configured to perform one or more AWB methods as described herein.

The Video BE (110) includes an on-screen display engine (OSD) (120) and a video analog encoder (VAC) (122). The OSD engine (120) includes functionality to manage display data in various formats for several different types of hardware display windows and it also handles gathering and blending of video data and display/bitmap data into a single display window before providing the data to the VAC (122) in a color space format (e.g., RGB, YUV, YCbCr). The VAC (122) includes functionality to take the display frame from the OSD engine (120) and format it into the desired output format and output signals required to interface to display devices. The VAC (122) may interface to composite NTSC/PAL video devices, S-Video devices, digital LCD devices, high-definition video encoders, DVI/HDMI devices, etc.

The memory interface (124) functions as the primary source and sink to modules in the Video FE (108) and the Video BE (110) that are requesting and/or transferring data to/from external memory. The memory interface (124) includes read and write buffers and arbitration logic.

The ICP (102) includes functionality to perform the computational operations required for compression and other processing of captured images. The video compression standards supported may include, for example, one or more of the JPEG standards, the MPEG standards, and the H.26x standards. In one or more embodiments of the invention, the ICP (102) may be configured to perform computational operations of methods for automatic white balance as described herein.

In operation, to capture a photograph or video sequence, video signals are received by the video FE (108) and converted to the input format needed to perform video compression. Prior to the compression, one or more methods for automatic white balance as described herein may be applied as part of processing the captured video data. The video data generated by the video FE (108) is stored in the external memory. The video data is then encoded, i.e., compressed. During the compression process, the video data is read from the external memory and the compression computations on this video data are performed by the ICP (102). The resulting compressed video data is stored in the external memory. The compressed video data is then read from the external memory, decoded, and post-processed by the video BE (110) to display the image/video sequence.

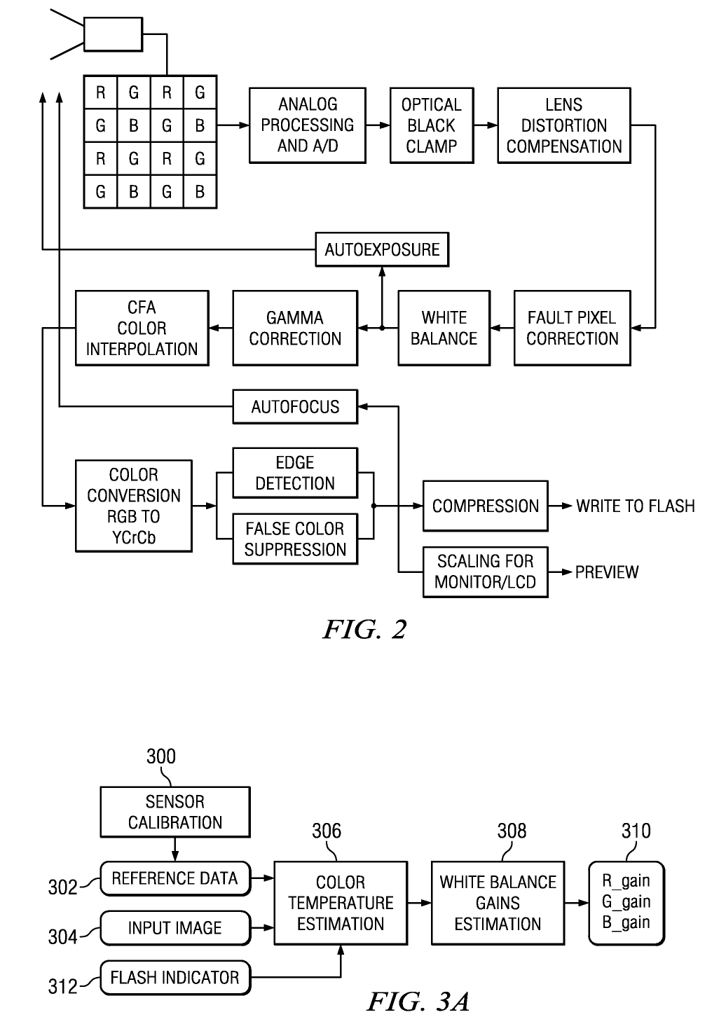

FIG. 2 is a block diagram illustrating digital camera control and image processing (the “image pipeline”) in accordance with one or more embodiments of the invention. One of ordinary skill in the art will understand that similar functionality may also be present in other digital systems (e.g., a cell phone, PDA, a desktop or laptop computer, etc.) capable of capturing digital photographs and/or digital video sequences. The automatic focus, automatic exposure, and automatic white balancing are referred to as the 3A functions; and the image processing includes functions such as color filter array (CFA) interpolation, gamma correction, white balancing, color space conversion, and compression/decompression (e.g., JPEG for single photographs and MPEG for video sequences). A brief description of the function of each block in accordance with one or more embodiments is provided below. Note that the typical color image sensor (e.g., CMOS or CCD) includes a rectangular array of photosites (i.e., pixels) with each photosite covered by a filter (the CFA): typically, red, green, or blue. In the commonly-used Bayer pattern CFA, one-half of the photosites are green, one-quarter are red, and one-quarter are blue.

To optimize the dynamic range of the pixel values represented by the imager of the digital camera, the pixels representing black need to be corrected since the imager still records some non-zero current at these pixel locations. The black clamp function adjusts for this difference by subtracting an offset from each pixel value, but clamping/clipping to zero to avoid a negative result.

Imperfections in the digital camera lens introduce nonlinearities in the brightness of the image. These nonlinearities reduce the brightness from the center of the image to the border of the image. The lens distortion compensation function compensates for the lens by adjusting the brightness of each pixel depending on its spatial location.

Photosite arrays having large numbers of pixels may have defective pixels. The fault pixel correction function interpolates the missing pixels with an interpolation scheme to provide the rest of the image processing data values at each pixel location.

The illumination during the recording of a scene is different from the illumination when viewing a picture. This results in a different color appearance that may be seen as the bluish appearance of a face or the reddish appearance of the sky. Also, the sensitivity of each color channel varies such that grey or neutral colors may not be represented correctly. In one or more embodiments of the invention, the white balance function compensates for these imbalances in colors in accordance with a method for automatic white balance as described herein.

Due to the nature of a color filter array, at any given pixel location, there is information regarding one color (R, G, or B in the case of a Bayer pattern). However, the image pipeline needs full color resolution (R, G, and B) at each pixel in the image. The CFA color interpolation function reconstructs the two missing pixel colors by interpolating the neighboring pixels.

Display devices used for image-viewing and printers used for image hardcopy have a nonlinear mapping between the image gray value and the actual displayed pixel intensities. The gamma correction function (also referred to as adaptive gamma correction, tone correction, tone adjustment, contrast/brightness correction, etc.) compensates for the differences between the images generated by the image sensor and the image displayed on a monitor or printed into a page.

Typical image-compression algorithms such as JPEG operate on the YCbCr color space. The color space conversion function transforms the image from an RGB color space to a YCbCr color space. This conversion may be a linear transformation of each Y, Cb, and Cr value as a weighted sum of the R, G, and B values at that pixel location.

The nature of CFA interpolation filters introduces a low-pass filter that smoothes the edges in the image. To sharpen the images, the edge detection function computes the edge magnitude in the Y channel at each pixel. The edge magnitude is then scaled and added to the original luminance (Y) image to enhance the sharpness of the image.

Edge enhancement is performed in the Y channel of the image. This leads to misalignment in the color channels at the edges, resulting in rainbow-like artifacts. The false color suppression function suppresses the color components, Cb and Cr, at the edges reduces these artifacts.

The autofocus function automatically adjusts the lens focus in a digital camera through image processing. These autofocus mechanisms operate in a feedback loop. They perform image processing to detect the quality of lens focus and move the lens motor iteratively until the image comes sharply into focus.

Due to varying scene brightness, to get a good overall image quality, it is necessary to control the exposure of the image sensor. The autoexposure function senses the average scene brightness and appropriately adjusting the image sensor exposure time and/or gain. Similar to autofocus, this operation is also in a closed-loop feedback fashion.

Most digital cameras are limited in the amount of memory available on the camera; hence, the image compression function is employed to reduce the memory requirements of captured images and to reduce transfer time.

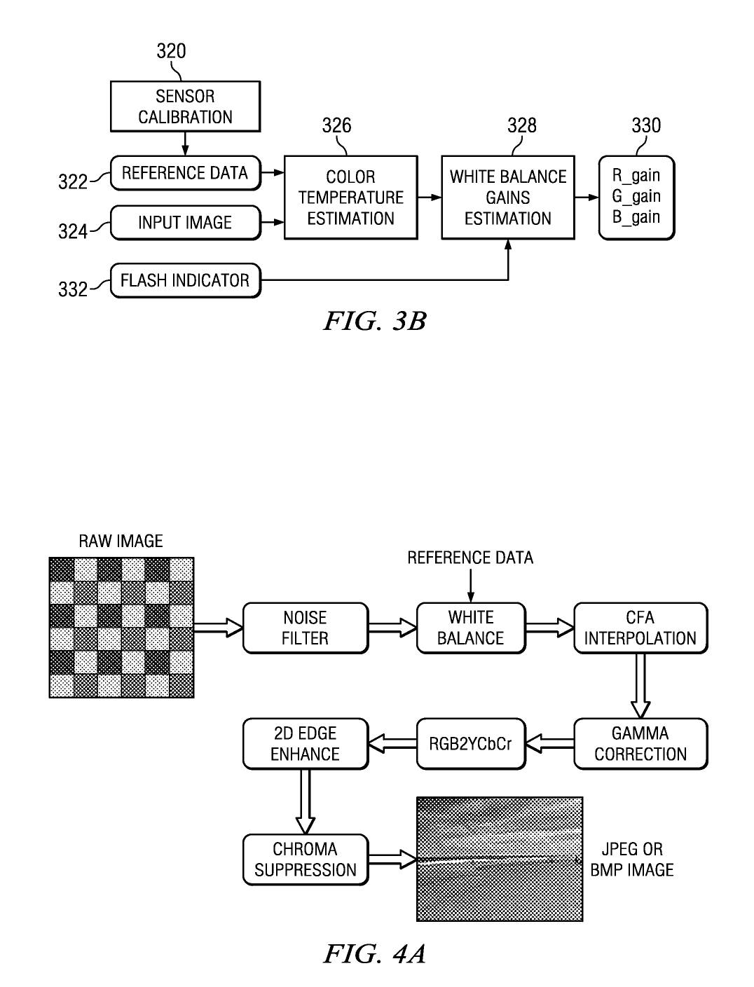

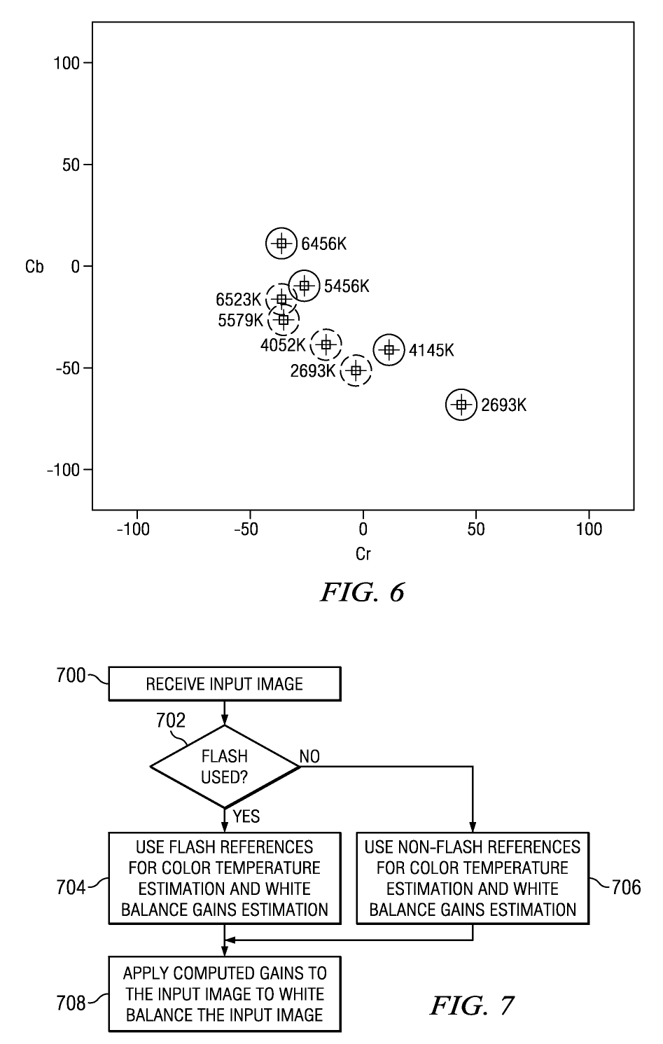

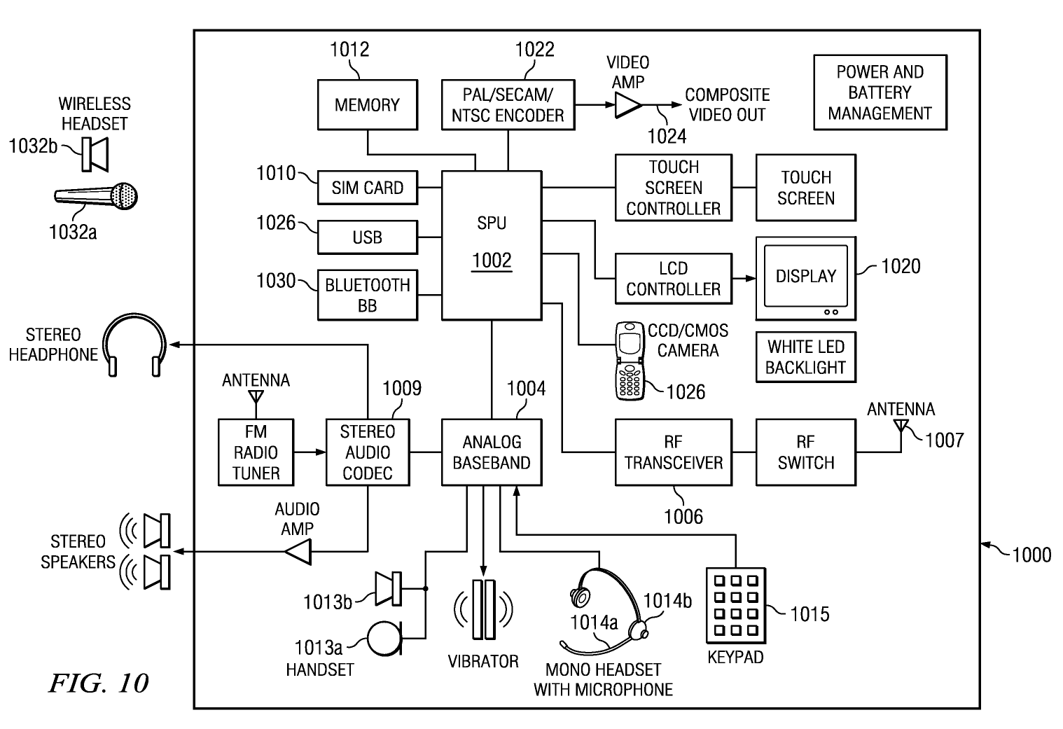

FIGS. 3A and 3B are block diagrams of AWB flow in accordance with one or more embodiments of the invention. Referring first to FIG. 3A, initially, sensor calibration is performed (300) to produce reference data (302) for calibration of an embodiment of an AWB method. The sensor calibration may be performed in accordance with an embodiment of a method for AWB calibration as described herein. As is described in more detail below, in one or more embodiments of the invention, the sensor calibration is performed using an AWB simulation system and an AWB calibration system and the resulting reference data (302) is integrated into a digital system (e.g., the digital systems of FIGS. 1 and 10) implementing an embodiment of an AWB method as described herein. The reference data (302) may include any suitable references, such as, for example, color temperature references, scene prototype references, and the like. In some embodiments of the invention, the reference data (302) includes flash references. Some suitable techniques for generation of color temperature references and scene prototype references are described in U.S. patent application Ser. No. 12/700,671 and U.S. patent application Ser. No. 12/710,344. A method for generation of flash references is described below in reference to FIGS. 5 and 6.

The reference data (302) is then used to perform automatic white balancing on an input image (304). The automatic white balancing includes performing color temperature estimation (306) and white balance gains estimation (308) using the reference data (302) and the input image (304). Suitable methods for color temperature estimation and white balance gains estimation are described in U.S. patent application Ser. No. 12/510,853. The outputs of the color temperature estimation (306) and white balance gains estimation (308) include the gains (310) (R_gain, G_gain, B_gain) to be applied to the color channels of the image (304) to generate a white balanced image. In one or more embodiments of the invention, when a flash is used while capturing the input image (304) as indicated by the flash indicator (332), the color temperature estimation (306) and white balance gains estimation (308) use flash references and not other available references, e.g., color temperature references. However, when a flash is not used, the color temperature estimation (306) and white balance gains estimation (308) use the other available references and not the flash references.

Referring now to FIG. 3B, initially, sensor calibration is performed (320) to produce reference data (302) for calibration of an embodiment of an AWB method. The sensor calibration may be performed in accordance with an embodiment of a method for AWB calibration as described herein. As is described in more detail below, in one or more embodiments of the invention, the sensor calibration is performed using an AWB simulation system and an AWB calibration system and the resulting reference data (322) is integrated into a digital system (e.g., the digital systems of FIGS. 1 and 10) implementing an embodiment of an AWB method as described herein. The reference data (322) may include any suitable references, such as for example, color temperature references, scene prototype references, and the like. Some suitable techniques for generation of color temperature references and scene prototype references are described in U.S. patent application Ser. No. 12/700,671 and U.S. patent application Ser. No. 12/710,344.

The reference data (322) is then used to perform automatic white balancing on an input image (324). The automatic white balancing includes performing color temperature estimation (326) and white balance gains estimation (328) using the reference data (322) and the input image (324). Suitable methods for color temperature estimation and white balance gains estimation are described in U.S. patent application Ser. No. 12/510,853. The outputs of the color temperature estimation (326) and white balance gains estimation (328) include the gains (330) (R_gain, G_gain, B_gain) to be applied to the color channels of the image (324) to generate a white balanced image. In one or more embodiments of the invention, when a flash is used while capturing the input image (324) as indicated by the flash indicator (332), the white balance gains estimation (326) applies predetermined flash gain ratio adjustments to the R_gain, G_gain, B_gain. Predetermined flash gain ratio adjustments are described in more detail herein in reference to FIG. 9.

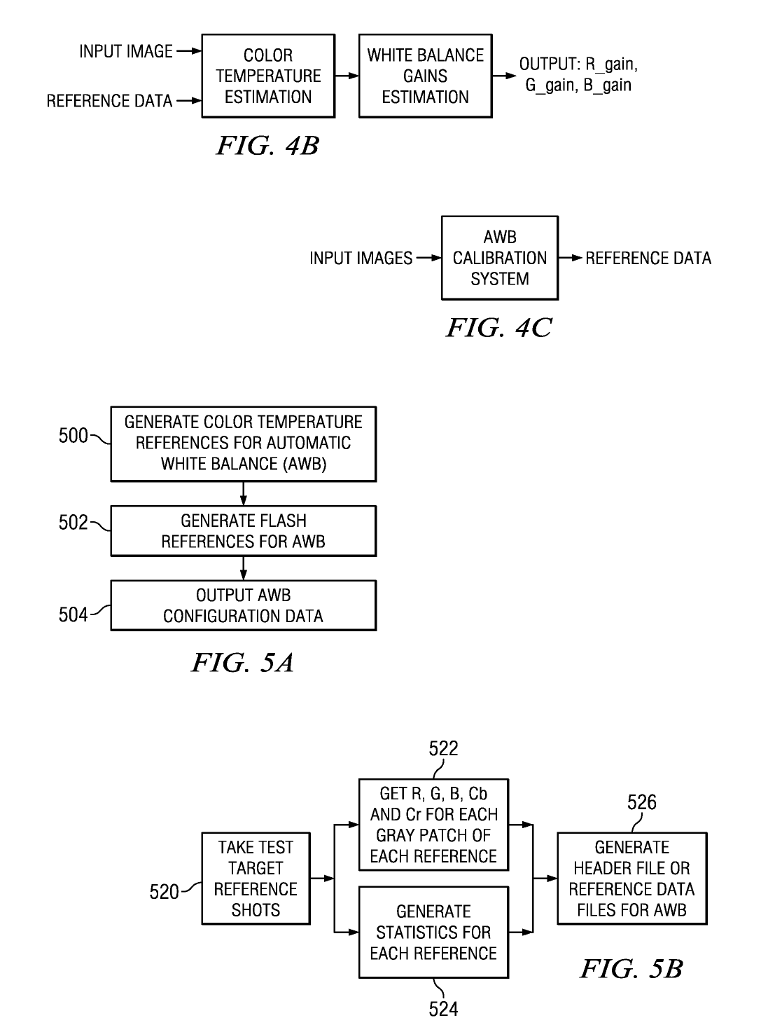

FIGS. 4A and 4B show block diagrams of a simulation system in accordance with one or more embodiments of the invention. In general, the simulation system simulates image pipeline processing. In some embodiments of the invention, the components of the simulation system shown in FIG. 4A simulate the functionality of image pipeline processing components in a target digital system (e.g., the digital systems of FIGS. 1 and 10) to support tuning, testing, calibration, etc. of the various components using one or more test suites of digital images. In one or more embodiments of the invention, the components of the simulation system of FIG. 4A simulate functionality of similarly named components in the image pipeline of FIG. 2.

Further, in some embodiments of the invention, as shown in FIG. 4B, the white balance component of FIG. 4A simulates an automatic white balance method that includes color temperature estimation and white balance gains estimation using reference data and the input image. Suitable methods for color temperature estimation and white balance gains estimation are described in U.S. patent application Ser. No. 12/510,853. The outputs of the color temperature estimation and white balance gains estimation include the gains (R_gain, G_gain, B_gain) to be applied to the color channels of the image to generate a white balanced image. In some embodiments of the invention, the simulation system also simulates one or more automatic white balance methods as described herein.

FIG. 4C is a block diagram of an AWB calibration system in accordance with one or more embodiments of the invention. In general, the AWB calibration system accepts input images captured with an image sensor and uses those images to generate reference data for calibrating AWB in a digital system having the type of image sensor used to capture the images. The reference data may include image statistics for each input image and/or gray values for each input image. In some embodiments of the invention, the image statistics are histograms.

FIG. 5A is a flow graph of a method for calibration of automatic white balancing (AWB) in a digital system in accordance with one or more embodiments of the invention. In general, calibration of AWB is the generation of reference statistics (e.g., histograms) and/or gray values for a target image sensor. As shown in FIG. 5, initially color temperature references are generated for calibration of AWB in the digital system (500). These initial references may be histograms and one or more gray values derived from images of a test target containing gray patches, such as a color checker, taken under a variety of color temperatures using the same type of image sensor as is included in the digital system. The test target may be any suitable color chart such as, for example, a Macbeth ColorChecker or a Macbeth ColorChecker SG.

In one or more embodiments of the invention, the color temperature references are generated in accordance with the method of FIG. 5B. As shown in FIG. 5B, initially digital images of the test target (e.g., a color checker) are captured with the image sensor in a light box under controlled lighting conditions to capture images of the test target with different color temperatures (520). The color temperatures may include, for example, one or more of A (2800K), U30 (3000K), CWF (4200K), TL84 (3800K), D50 (5000K), D65 (6500K), and D75 (7500K).

Then, statistics are generated for each of the test target images (524). In one or more embodiments of the invention, 2-D histograms of the test target images in the Cb-Cr space are computed. The histograms may be computed by quantizing the Cb into N (e.g., N=35) bins and Cr into M (e.g., M=32) bins, and counting the number of blocks or pixels falling into each Cr and Cb bin. In some embodiments of the invention, the images are downsampled before the histograms are generated.

In addition, the R, G, B, Cb and Cr values of one or more gray levels are extracted from gray patches in each of the test target images (522). The number of gray patches from which gray values are extracted may vary. For example, if the test target is a Macbeth ColorChecker, there are six gray patches of different gray color levels available. In one or more embodiments of the invention, the gray patches corresponding to the middle four gray levels are used, i.e., gray values are extracted from these four gray patches. The white patch is not used because of saturation issues and the black patch is not used because of large quantization errors.

In some embodiments of the invention, the R, G, B values for a gray patch are computed as the averages of the R, G, B values of pixels in the gray patch. In some embodiments of the invention, only a selected subset of the pixels (e.g., a center block of pixels in the gray patch) is used to compute the R, G, B values of the gray patch. Further, the Cb and Cr values for a gray patch are computed based on the R, G, B values. The Cb and Cr values may be computed as

Y=0.299R+0.587G+0.114B

Cb=256(−0.1726R−0.3388G+0.5114B)/Y

Cr=256(0.5114R−0.4283G−0.0832B)/Y

The scale factors used in the above equations may be known industry standard scale factors for converting from R, G, B to Cb and Cr or may be experimentally derived scale factors. In the above equations, Cb and Cr are normalized by Y. In other embodiments of the invention, Cb and Cr may be computed as shown above without normalization by Y.

The statistics and gray values for the images are then included in the set of reference data for AWB in the digital system (626).

Referring again to FIG. 5A, flash references are also generated for calibration of AWB in the digital system for used in AWB of digital images captured using a flash (502). These initial references may be histograms and one or more gray values derived from images of a test target containing gray patches, such as a color checker, taken under a variety of color temperatures using the same type of image sensor as is included in the digital system and using a flash of the same light intensity as is included in the digital system. The test target may be any suitable color chart such as, for example, a Macbeth ColorChecker or an Macbeth ColorChecker SG. In one or more embodiments of the invention, the color checker used is the same color checker used to generate the color temperature references.

In one or more embodiments of the invention, the flash references are generated in the same way as the color temperature references, except that the flash is used when capturing the images. That is, as shown in FIG. 5B, initially digital images of the test target (e.g., a color checker) are captured with the image sensor and the flash in a light box under controlled lighting conditions to capture images of the test target with different color temperatures (520). The color temperatures may include, for example, one or more of A (2800K), U30 (3000K), CWF (4200K), TL84 (3800K), D50 (5000K), D65 (6500K), and D75 (7500K). Two particularly important color temperatures to be used are TL84 and U30 as these color temperatures are most often the color temperature when a flash is used. Then, statistics are generated for each of the test target images (524) and the R, G, B, Cb and Cr values of one or more gray levels are extracted from gray patches in each of the test target images (522) as previously described. The statistics and gray values for the images are then included in the set of reference data for AWB in the digital system (526).

FIG. 6 shows a graph comparing flash references against color temperature references of the same color temperature in the normalized CbCr chromaticity space as measured using a camera in a cellular telephone. The points with the dotted circles are the flash references and the points with the solid circles are the color temperature references. These circles around the reference points show the region around the reference point most likely to be gray. As can be seen from this graph: (1) the flash references have significantly deviated from the color temperature references, indicating the need for a special flash white balance; and (2) the flash references are located in a much more compact region than the color temperature references but they do not overlap as the color temperature changes. This latter case is due to the strong ambient light influence which is particularly true for camera phones. This shows that more than one flash reference may be needed to achieve acceptable white balancing of images taken with a flash especially in a camera phone where the flash may not be strong enough to overcome the ambient light influence.

FIG. 7 is a flow graph of a method for automatic white balancing (AWB) of a digital image in a digital system in accordance with one or more embodiments of the invention. In general, embodiments of the method provide for white balancing using flash references when a digital image is captured using a flash. Initially, an input digital image is received (700). A determination is then made as to whether a flash was used in capturing the digital image (702). For example, a flash indicator may be set in the digital system when the flash is used, and that indicator may be checked. If the flash was used, then flash references are used for color temperature estimation and white balance gains estimation to generate a red gain R_{gain}, a green gain G_{gain}, and a blue gain B_{gain} to be applied to the image for white balancing (704). Otherwise, other references that were generated without using a flash are used for color temperature estimation and white balance gains estimation to generate the R_{gain}, G_{gain}, and B_{gain} values (706).

The computed gains are then applied to the digital image to white balance the image (708). That is, an white-balanced image may be obtained by individually scaling the R, G, and B channels of the image with the R_{gain}, G_{gain}, and B_{gain} values as follows:

$$[ \begin{matrix}{R}_{adapt} \\ {G}_{adapt} \\ {B}_{adapt}\end{matrix} ] = [ \begin{matrix}{R}_{gain} & 0 & 0 \\ 0 & {G}_{gain} & 0 \\ 0 & 0 & {B}_{gain}\end{matrix} ] [ \begin{matrix}{R}_{input} \\ {G}_{input} \\ {B}_{input}\end{matrix} ]$$

where Rᵢₙₚᵤₜ, Gᵢₙₚᵤₜ, and Bᵢₙₚᵤₜ are the R, G, and B values of the input pixels and R_{adapt}, G_{adapt}, and B_{adapt} are the resulting R, G, and B values with the computed gains applied.

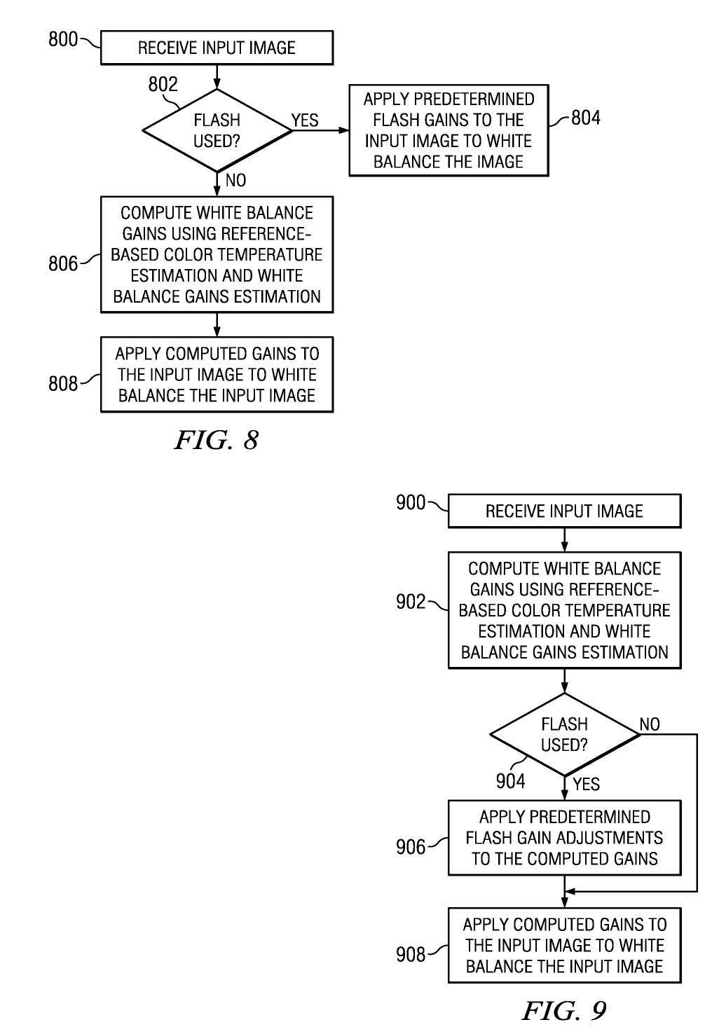

FIG. 8 is a flow graph of a method for automatic white balancing (AWB) of a digital image in a digital system in accordance with one or more embodiments of the invention. In general, embodiments of the method provide for white balancing using predetermined flash gains when a digital image is captured using a flash. This method is based on the observation that the flash is likely to be the dominant light source even when other illumination is present. This is generally true for digital cameras. In this case, using fixed values for the white balance gains that assume the flash is the dominant light source may provided better white balancing for images taken with a flash than using the gains computed by reference-based AWB using references that do not take into account the effect of a flash.

As shown in FIG. 8, initially, an input digital image is received (800). A determination is then made as to whether a flash was used in capturing the digital image (802). For example, a flash indicator may be set in the digital system when the flash is used, and that indicator may be checked. If the flash was not used, then references are used for color temperature estimation and white balance gains estimation to generate a red gain R_{gain}, a green gain G_{gain}, and a blue gain B_{gain} to be applied to the image for white balancing (806). These computed gains are then applied to the digital image to white balance the image (808) as previously described.

If a flash was used, predetermined flash gain values for R_{gain}, G_{gain}, and B_{gain} values (804) are applied to the digital image to white balance the image (804) as previously described. The predetermined flash value gains may be experimentally determined and loaded into the digital system. For example, the gains may be computed by measuring the R, G, and B values of gray patches in images captured using the same type of sensor as is included in the digital system and using a flash of the same light intensity as that included in the digital system. The images may be taken under a variety of color temperatures using the flash. The R, G, and B values from the gray patches may then be averaged to generate R_{flash}, G_{flash}, and B_{flash}. The flash gains may then be computed as

$${R}_{gain} = \frac{{G}_{flash}}{{R}_{flash}} , {B}_{gain} = \frac{{G}_{flash}}{{B}_{flash}} , \\ and$$

$${G}_{gain} = 1.0$$

or equivalently as

$${F}_{gain} = \frac{max \{ {R}_{flash} , {G}_{flash} , {B}_{flash} \}}{{F}_{flash}} , \\ F = R , G , or B$$

The latter formulation ensure that the minimal R, G, B gains will be greater than or equal to 1.0.

FIG. 9 is a flow graph of a method for automatic white balancing (AWB) of a digital image in a digital system in accordance with one or more embodiments of the invention. In general, embodiments of the method provide for white balancing using references in which predetermined flash gain adjustments are applied to the gains computed by AWB when a digital image is captured using a flash. This method is based on the observation that the reference-based AWB may leave a greenish/bluish color cast in an image captured with a flash. Therefore, to compensate, the computed R_{gain} could be boosted by some amount and the computed B_{gain} and/or G_{gain} reduced by some amount.

As shown in FIG. 9, initially, an input digital image is received (900). References are then used for color temperature estimation and white balance gains estimation to generate a red gain R_{gain}, a green gain G_{gain}, and a blue gain B_{gain} to be applied to the image for white balancing (902). A determination is then made as to whether a flash was used in capturing the digital image (904). For example, a flash indicator may be set in the digital system when the flash is used, and that indicator may be checked. If a flash was not used, the computed gains are then applied to digital image to white balance the image (908) as previously described.

If a flash was used, predetermined flash gain adjustments R_{adjust}, G_{adjust}, and B_{adjust} are applied to the R_{gain}, G_{gain}, and B_{gain} values, respectively, to compensate for the use of the flash (906). These predetermined flash gain adjustments may be applied as follows:

F_{gain}= F̅_̅{̅g̅a̅i̅n̅}̅*F_{adjust},F=R,G, or B

where F̅_̅{̅g̅a̅i̅n̅}̅ is the computed gain value for each of R, G, and B and F_{gain} is the flash adjusted gain value for each of R, G, and B. The predetermined flash gain adjustment may be, for example, R_{adjust}=1.1, B_{adjust}=0.9, and G_{adjust}=1.0. The flash adjusted gain values are then applied to the digital image to white balance the image (908) as previously described.

The predetermined flash gain adjustments may be experimentally determined, and may be differ based on the image sensor used and the flash used. For example, a simulation system such as that of FIGS. 4A and 4B may be used to apply referenced-based AWB to a test set of images captured using the same type of image sensor as is included in the digital system and using a flash of the same light intensity as is included in the digital system. Different adjustment values could then be applied to the computed AWB gains and the results observed. If the images look bluish, this suggests a need to increase the gain for red and to perhaps decrease the gain for blue. If the images look reddish, the gain for red may need to be suppressed and that for the blue boosted. The adjustment values that provide the best overall white balance results could then be loaded into the digital system for use. In another example, R, G, and B values taken from a gray patch captured using the same type of image sensor and flash may be used to guide the selection of the adjustment values for the gains.

Tests have shown that the more computationally efficient methods of FIGS. 8 and 9 may be more effective when a powerful flash, such as that of a digital camera, which dominates the lighting of a scene being photographed is used than when a weaker flash such as that included in a camera phone is used. For the latter case, the illumination in the captured image may be more strongly influenced by other lighting in the scene, and the method of FIG. 7, i.e., using flash references, while more computationally complex, may provide better results.

In some embodiments of the invention, a combination of the above methods may be used for white balancing of digital images captured using a flash. For example, a digital system for capturing images may be equipped to detect when use of the flash dominates the scene illumination or when the illumination is less dominated by the flash. When the illumination is dominated by the flash, one of the methods of FIGS. 8 and 9 may be used for white balancing, and when the illumination is less dominated by the flash, the flash reference method of FIG. 7 may be used for white balancing.

Embodiments of the methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing including embodiments of the methods for AWB described herein. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

Embodiments of the methods described herein may be implemented in hardware, software, firmware, or any combination thereof. If implemented at least partially in software, the software may be executed in one or more processors, such as a microprocessor, application specific integrated circuit (ASIC), field programmable gate array (FPGA), or digital signal processor (DSP). The software embodying the methods may be initially stored in a computer-readable medium (e.g., memory, flash memory, a DVD, USB key, etc.) and loaded and executed by a processor. Further, the computer-readable medium may be accessed over a network or other communication path for downloading the software. In some cases, the software may also be provided in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Embodiments of the AWB methods as described herein may be implemented for virtually any type of digital system (e.g., a desk top computer, a laptop computer, a handheld device such as a mobile (i.e., cellular) phone, a personal digital assistant, a digital camera, etc., with functionality to capture digital images using an image sensor. FIG. 10 shows a block diagram of an illustrative digital system.

FIG. 10 is a block diagram of a digital system (e.g., a mobile cellular telephone with a camera) (1000) that may be configured to perform the methods described herein. The signal processing unit (SPU) (1002) includes a digital signal processor system (DSP) that includes embedded memory and security features. The analog baseband unit (1004) receives a voice data stream from handset microphone (1013a) and sends a voice data stream to the handset mono speaker (1013b). The analog baseband unit (1004) also receives a voice data stream from the microphone (1014a) and sends a voice data stream to the mono headset (1014b). The analog baseband unit (1004) and the SPU (1002) may be separate integrated circuits. In many embodiments, the analog baseband unit (1004) does not embed a programmable processor core, but performs processing based on configuration of audio paths, filters, gains, etc. being setup by software running on the SPU (1002). In some embodiments, the analog baseband processing is performed on the same processor and can send information to it for interaction with a user of the digital system (1000) during a call processing or other processing.

The display (1020) may also display pictures and video streams received from the network, from a local camera (1028), or from other sources such as the USB (1026) or the memory (1012). The SPU (1002) may also send a video stream to the display (1020) that is received from various sources such as the cellular network via the RF transceiver (1006) or the camera (1026). The camera (1026) may be equipped with a flash (not shown). The SPU (1002) may also send a video stream to an external video display unit via the encoder (1022) over a composite output terminal (1024). The encoder unit (1022) may provide encoding according to PAL/SECAM/NTSC video standards.

The SPU (1002) includes functionality to perform the computational operations required for video encoding and decoding. The video encoding standards supported may include, for example, one or more of the JPEG standards, the MPEG standards, and the H.26x standards. In one or more embodiments of the invention, the SPU (1002) is configured to perform computational operations of an AWB method on digital images captured by the camera (1026) as described herein. Software instructions implementing the method may be stored in the memory (1012) and executed by the SPU (1002) as part of capturing digital image data, e.g., pictures and video streams.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method for automatic white balance (AWB) in a digital system, the method comprising:
applying predetermined flash red, blue, and green gain values stored in the digital system to white balance a digital image when a flash is used to capture the digital image; and
applying computed red, blue, and green gain values to white balance a digital image when the flash is not used to capture the digital image.

2. The method of claim 1, wherein the predetermined flash red, blue, and green gain values are determined as
$${R}_{gain} = \frac{{G}_{flash}}{{R}_{flash}} , {B}_{gain} = \frac{{G}_{flash}}{{B}_{flash}} , \\ and$$
$${G}_{gain} = 1.0$$
wherein R_{flash}, G_{flash}, and B_{flash} are experimentally determined average red, blue, and green values, and R_{gain}, B_{gain}, and G_{gain} are the predetermined respective red, blue, and green value.

3. The method of claim 1, wherein the predetermined flash red, blue, and green gain values are determined as
$${F}_{gain} = \frac{max \{ {R}_{flash} , {G}_{flash} , {B}_{flash} \}}{{F}_{flash}} , \\ F = R , G , or B$$
wherein R_{flash}, G_{flash}, and B_{flash} are experimentally determined average red, blue, and green values.

4. The method of claim 1, wherein applying computed red, blue, and green gain values comprises computing the red, blue, and green gain values using reference-based color temperature estimation and white balance gains estimation.

5. The method of claim 1, wherein the predetermined flash red, blue, and green gain values are determined based on a type of image sensor in the digital system and a light intensity of a flash in the digital system.

6. A method for automatic white balance (AWB) in a digital system, the method comprising:
computing red, blue, and green gain values for white balancing a digital image;
applying the computed red, blue, and green gain values to white balance the digital image when a flash is not used to capture the digital image;
adjusting the computed red, blue, and green gain values with respective predetermined flash red, blue, and green gain adjustment values when the flash is used to capture the digital image; and
applying the adjusted red, blue, and green gain values to white balance the digital image.

7. The method of claim 6, wherein computing the red, blue, and green gain values comprises computing the red, blue, and green gain values using reference-based color temperature estimation and white balance gains estimation.

8. The method of claim 6, wherein applying the adjusted red, blue, and green values comprises multiplying the computed red, blue, and green gain values by the respective predetermined flash red, blue, and green gain adjustment values.

9. The method of claim 6, wherein the predetermined flash red, blue, and green gain adjustment values are determined based on a type of image sensor in the digital system and a light intensity of a flash in the digital system.

10. A digital system comprising:
a processor;
a first image sensor;
a flash; and
an automatic white balance (AWB) component, wherein the automatic white balance component is operable to use at least one flash reference to white balance a digital image captured using the first image sensor and the flash, and to use non-flash references to white balance a digital image captured using the first image sensor without using the flash.

11. The digital system of claim 10, wherein the non-flash references comprise color temperature references.

12. The digital system of claim 11, wherein each color temperature reference of the color temperature references is generated by
capturing an image of a test target at a color temperature to generate a color temperature image;
generating a histogram of the color temperature image; and
extracting gray values from gray patches in the color temperature image.

13. The digital system of claim 12, wherein the at least one flash reference is generated by
capturing, using a flash, an image of the test target at a same color temperature used to generate a color temperature image to generate a flash image;
generating a histogram of the flash image; and
extracting gray values from gray patches in the flash image.

14. The digital system of claim 13, wherein the color temperature is one selected from a group consisting of A (2800K), U30 (3000K), CWF (4200K), TL84 (3800K), D50 (5000K), D65 (6500K), and D75 (7500K).
